(19) United States
(12) Patent Application Publication
(10) Pub. No.: US 2017/0016558 A1
(43) Pub. Date: Jan. 19, 2017

(54) HOSE FOR CONVEYING FLUIDS

(71) Applicant: Caterpillar Inc., Peoria, IL (US)

(72) Inventors: Gary Michael Weilani Steen, Peoria, IL (US); Stefano Morone, Carugate (IT)

(73) Assignee: Caterpillar Inc., Peoria, IL (US)

(21) Appl. No.: 15/281,249

(22) Filed: Sep. 30, 2016

(51) Int. Cl. F16L 11/02; F16L 11/10

(52) U.S. Cl. CPC F16L 11/02; F16L 11/10

(57) ABSTRACT

A hydraulic hose for conveying a fluid is provided. The hydraulic hose includes a liner. The hydraulic hose also includes a first braided layer surrounding the liner. The hydraulic hose further includes a helical wire spirally wound on the first braided layer. The hydraulic hose includes a second braided layer surrounding the helical wire. The helical wire is provided between the first and second braided layers. The hydraulic hose also includes a cover surrounding the second braided layer.

### TECHNICAL FIELD

The present disclosure relates to a hose, and more particularly a hydraulic hose for conveying a fluid.

### BACKGROUND

Hoses are used in a variety of industrial applications for conveying or transferring fluids. For example, the hose may be used for conveying high pressure hydraulic fluid in a hydraulic application. Some industrial applications require the hose to be kink resistant or collapse resistant.

Typically, the hose includes a liner and a cover. The hose also includes one or more intermediate layers that are either wire reinforced or textile reinforced. Hoses having a large bore and wire reinforced intermediate layers may tend to kink/collapse in high pressure applications. Thus, in such applications, wire spiral hoses are used. However, the wire spiral hoses are costly and may increase an overall cost associated with the hose.

U.S. Pat. No. 5,647,400 describes a polyfluorocarbon/elastotner bonded laminate. Further, a flexible, durable chemical-resistant hose including inner tube members characterized by a dual-layer feature employing such laminate is also described. The hose comprises an adhesive elastomeric composition which bonds a polyfluorocarbon thermoplastic veneer to a substantially non-polar chemical-resistant carbon-based elastomeric or thermoplastic elastomeric outer laver. The adhesive elastomeric composition comprises unsaturated polymeric dicarboxylic acids, or derivative adducts, of ethylene propylene diene terpolymer.

### SUMMARY OF THE DISCLOSURE

In one aspect of the present disclosure, a hydraulic hose for conveying a fluid is provided. The hydraulic hose includes a liner. The hydraulic hose also includes a first braided layer surrounding the liner. The hydraulic hose further includes a helical wire spirally wound on the first braided layer. The hydraulic hose includes a second braided layer surrounding the helical wire. The helical wire is provided between the first and second braided layers. The hydraulic hose also includes a cover surrounding the second braided layer.

Other features and aspects of this disclosure will be apparent from the following description and the accompanying drawings.

### BRIEF DESCRIPTION OF THE DRAWINGS

FIG. 1 is a perspective view of an exemplary machine, according to various concepts of the present disclosure, and

FIG. 2 is an exploded view of a hydraulic hose associated with the machine of FIG. 1, according to various concepts of the present disclosure.

### DETAILED DESCRIPTION

Wherever possible, the same reference numbers will be used throughout the drawings to refer to the same or the like parts, Also, corresponding or similar reference numbers will be used throughout the drawings to refer to the same or corresponding parts.

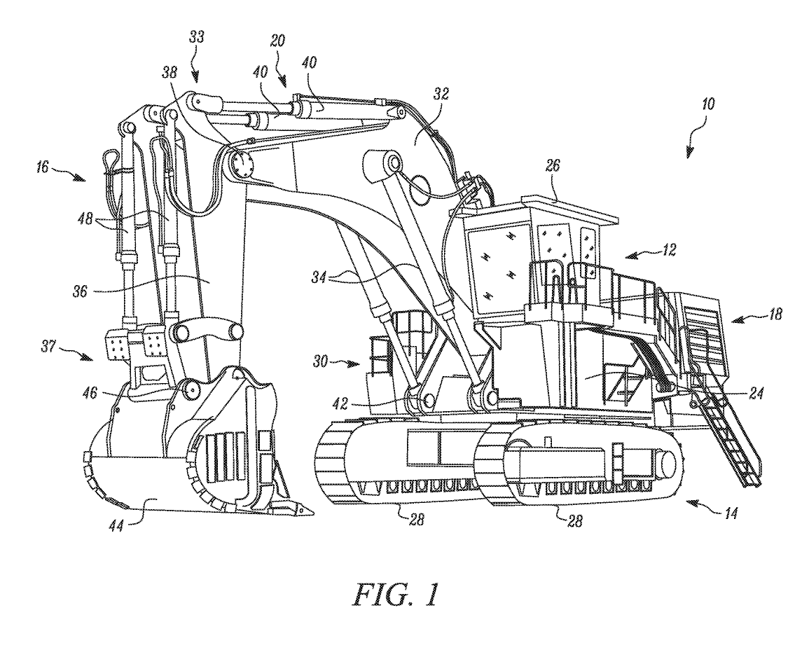

Referring to FIG. 1, an exemplary machine 10 is illustrated. The machine 10 is a hydraulic shovel. In one example, the machine 10 may embody a hydraulic mining shovel, without any limitations. Alternatively, the machine 10 may include, but is not limited to, an excavator, a wheel loader, a backhoe loader, a track type tractor, a drilling machine, a hammer, etc., without any limitations. The machine 10 may be associated with an industry including, but not limited to, transportation, construction, agriculture, forestry, power generation, and material handling,

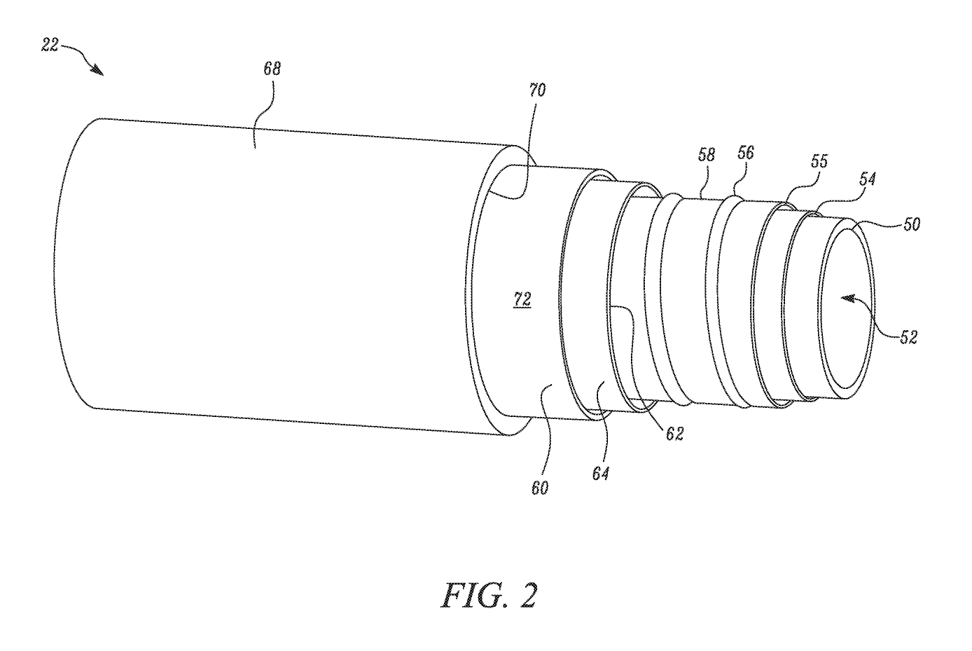

The machine 10 includes an upper section 12, a lower section 14, and a linkage assembly 16. Each of the upper section 12, the lower section 14, and the linkage assembly 16 is operated by a hydraulic system 20 that is powered by an engine (not shown) disposed in a rear end 18 of the upper section 12, Further, the hydraulic system 20 may include hydraulic cylinders, hydraulic pumps, hydraulic motors, etc. The hydraulic system 20 also includes hydraulic hoses for conveying a hydraulic fluid, one such hydraulic hose 22 shown in FIG. 2 will be explained in detail later in this section. Further, the hydraulic system 20 also includes a tank (not shown) for storage of the hydraulic fluid. Some components of the hydraulic system 20 are illustrated in the accompanying figures.

The upper section 12 is rotatably mounted on the lower section 14. The upper section 12 of the machine 10 includes a body 24. Further, an operator cabin 26 is positioned on the body 24. An operator seated in the operator cabin 26 may control an operation of the machine 10. The upper section 12 is supported on the lower section 14 by swing bearings (not shown). The upper section 12 rotates as a result of an actuation of a hydraulic motor (not shown) that engages a set of inner teeth in the swing bearings. Further, the lower section 14 of the machine 10 includes tracks 28. The tracks 28 are embodied as ground engaging members that allow movement of the machine 10 on a ground surface. In an alternate embodiment, the machine 10 may include wheels for movement of the machine 10, without any limitations.

Further, the machine 10 includes the linkage assembly 16 coupled to a front end 30 of the upper section 12. The linkage assembly 16 includes a boom 32 which is pivotally coupled to the body 24, The boom 32 is swingably connected to the front end 30 of the body 24. A hydraulic cylinder 34 (or a pair of cylinders) of the hydraulic system 20, controlled by the operator sitting in the operator cabin 26 or by a machine control system, moves the boom 32 relative to the body 24 about a pivot point 42 during operation.

Also, a stick 36 is pivotally coupled at a pivot point 38 to an outer end 33 of the boom 32 such that it can swing to-and-fro. A hydraulic cylinder 40 of the hydraulic system 20 moves the stick 36 relative to the boom 32. Further, an implement 44, such as a bucket, is pivotally coupled at a pivot point 46 to an outer end 37 of the stick 36. A hydraulic cylinder 48 of the hydraulic system 20 may move the implement 44 relative to the stick 36 about the pivot point 46.

Although only three hydraulic cylinders 34, 40, 48 are illustrated in the accompanying figures, it should be noted that the machine 10 may include any number of hydraulic cylinders, based on application requirements, without any limitations. Further, each hydraulic cylinder 34, 40, 48 may be actuated by respective hydraulic pumps associated with the hydraulic system 20. As mentioned above, the hydraulic system 20 includes a number of the hydraulic hoses that provide fluid communication between various components of the hydraulic system 20. More particularly, a high pressure line that fluidly connects the hydraulic cylinders 34, 40, 48 with the respective hydraulic pumps includes a high pressure hydraulic hose. The high pressure hydraulic hose is subjected to relatively high pressures during operation of the machine 10. Further, a low pressure line that provides fluid communication between the hydraulic cylinders 34, 40, 48 and the tank includes a low pressure hydraulic hose. Also, a suction hydraulic hose fluidly connects the tank and the hydraulic pump for suction of the hydraulic fluid into the hydraulic pump.

An exploded view of the hydraulic hose 22 is shown in FIG. 2. The hydraulic hose 22 may embody any one of the high pressure hydraulic hose, low pressure hydraulic hose, and the suction hose, without limiting the scope of the present disclosure. The hydraulic hose 22 includes a liner 50. The liner 50 forms a core of the hydraulic hose 22. The liner 50 defines an inner radius of the hydraulic hose 22. Further, the liner 50 defines a flow path 52 for the hydraulic fluid. The liner 50 is made of an elastomer. In one example, the elastomer is a rubber. A type of the elastomer may vary based on the pressure of the hydraulic fluid flowing through the hydraulic hose 22 and a type of the hydraulic fluid, without any limitations. In some examples, the liner 50 may include a layered composite structure.

The hydraulic hose 22 also includes a first braided layer 54. The first braided layer 54 surrounds the liner 50. The first braided layer 54 includes an interwoven braided structure made of a wire having high tensile strength. In one example, the first braided layer 54 may be made of a metal wire, such as a high tensile steel wire.

Further, the hydraulic hose 22 includes a first cushion layer 55. The first cushion layer 55 may be embodied as an elastomeric layer that acts as a cushion or a friction layer provided between the first braided layer 54 and a helical wire 56. The first cushion layer 55 may be made of a rubber blend. The first cushion layer 55 surrounds the first braided layer 54, such that the first braided layer 54 is positioned between the liner 50 and the first cushion layer 55.

Further, the hydraulic hose 22 includes the helical wire 56. The helical wire 56 is spirally wound on an outer surface 58 of the first cushion layer 55. The helical wire 56 may be spirally wound under tension on the first cushion layer 55. The helical wire 56 extends along an entire length of the hydraulic hose 22. The helical wire 56 may be wound at a predetermined pitch angle to define a series of turns that are equally spaced apart from each other. Further, the pitch angle may be decided based on a desired strength of the hydraulic hose 22.

The helical wire 56 may be made of a wire having a high tensile strength. The helical wire 56 may include a metal wire. In one example, the helical wire 56 is a steel wire, such as a carbon steel wire or a stainless steel wire, without limiting the scope of the present disclosure. In one example, the material of the helical wire 56 is decided based on the pressure to which the hydraulic hose 22 is subjected. The helical wire 56 may include a circular cross-section, an oval cross-section, or an elliptical cross-section. Alternatively, the helical wire 56 may include a fiat-wire construction having a polygonal cross-section. In such an example, the helical wire 56 may include a rectangular cross-section or a square cross-section.

The hydraulic hose 22 includes a second cushion layer 64, The second cushion layer 64 may be embodied as an elastomeric layer that acts as a cushion or a friction layer provided between a second braided layer 60 and the helical wire 56. The second cushion layer 64 may be made of a rubber blend. The second cushion layer 64 surrounds the helical wire 56, such that the helical wire 56 is positioned between the first and second cushion layers 55, 64. An inner surface 62 of the second cushion layer 64 contacts the helical wire 56.

Further, the second braided layer 60 includes an interwoven braided structure made of a wire having high tensile strength. In one example, the second braided layer 60 may be made of a metal wire, such as a high tensile steel wire. The hydraulic hose 22 also includes a cover 68, The cover 68 forms an outermost layer of the hydraulic hose 22. The cover 68 surrounds the second braided layer 60, such that an inner surface 70 of the cover 68 is in contact with an outer surface 72 of the second braided layer 60, The cover 68 defines an outer radius of the hydraulic hose 22.

The cover 68 may be braided or wrapped on the second braided layer 60. Further, the cover 68 is made of an elastomer. In one example, the elastomer is a rubber. A type of the elastomer may vary based on the pressure of the hydraulic fluid flowing through the hydraulic hose 22, without any limitations. In some examples, the cover 68 may include a layered composite structure. Further, each of the liner 50, the layers 54, 55, the helical wire 56, the layers 60, 64, and the cover 68 of the hydraulic hose 22 may be bonded to provide efficient transfer of stresses.

### INDUSTRIAL APPLICABILITY

The present disclosure relates to the hydraulic hose 22 having the helical wire 56. The helical wire 56 is positioned between the first and second cushion layers 55, 64. Provision of the helical wire 56 improves kink resistance and collapse resistance of the hydraulic hose 22. The helical wire 56 also enhances stiffness and service life of the hydraulic hose 22 especially in applications where the hydraulic hose 22 is subjected to high pressures. The disclosure provides a cost-effective hydraulic hose design that improves structural strength and performance life of the hydraulic hose 22.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A hydraulic hose for conveying a fluid, the hydraulic hose comprising:
a liner;
a first braided layer surrounding the liner;
a helical wire spirally wound on the first braided layer;
a second braided layer surrounding the helical wire, wherein the helical wire is provided between the first and second braided layers; and
a cover surrounding the second braided layer.
